(19) United States
(12) Patent Application Publication
(10) Pub. No.: US 2026/0048968 A1
(43) Pub. Date: Feb. 19, 2026

(54) CONTROL DEVICE FOR A LIFTING PLATFORM WITH INTEGRATED ENERGY STORAGE DEVICE

(71) Applicant: MAHA Maschinenbau Haldenwang GmbH & Co. KG, Haldenwang (DE)

(72) Inventors: Benjamin FÜRHAUPTER, Altusried (DE); Thomas FELDMEIER, Altusried (DE)

(21) Appl. No.: 19/101,767

(22) PCT Filed: Jul. 3, 2023
(86) PCT No.: PCT/EP2023/068169

§ 371 Date: Feb. 6, 2025

(30) Foreign Application Priority Data
Sep. 6, 2022 (DE) 10 2022 209 268.6

(51) Int. Cl. B66F 7/28; B66F 3/46

(52) U.S. Cl. CPC B66F 7/28; B66F 3/46

(57) ABSTRACT

The present disclosure relates to a control device 4 for a lifting platform 10 with an integrated energy storage 4e, and to a lifting platform 10, in particular a mobile lifting platform for vehicles, which has the control device 4, and to a system which contains one or more of the lifting platforms 10.

The present disclosure relates to a control device for a lifting platform with an integrated energy storage device, and to a lifting platform, in particular a mobile lifting platform for vehicles, which has the control device, and to a system which contains one or more of the lifting platforms.

So-called Mobile column lifting platforms are mobile and sit on the wheels of a vehicle in order to lift it. As a result, this type of lifting platform is very flexible and can be used for a wide variety of vehicle types. Mobile column lifting platforms can be used both independently of location in a workshop and outdoors. The use of an accumulator for supplying voltage also makes it possible to use it independently of an existing power connection. This distinguishes mobile mobile column lifting platforms, for example, from stationary 2-column lifting platforms which are installed permanently at one location and are limited to the lifting of specific vehicle types.

Patent literature 1 discloses a mobile lifting column, in particular for lifting motor vehicles, which comprises a lifting device, a drive means for lifting and lowering the lifting device and at least one battery for supplying the at least one drive means. In order to also be able to charge the battery independently of existing infrastructure, a solar panel is additionally provided which is electrically connected to the battery. The battery is in this case attached to the foot of the lifting column on a side facing away from the lifting device. However, this position of the battery and the weight thereof can be a hindrance when moving the mobile lifting column and/or when positioning the lifting device under a vehicle with a low ground clearance.
Patent Literature 1: DE 10 2009 002 884 A1

An object of the subject matter disclosed here is to provide a control device for a lifting platform, in particular for a mobile lifting platform for vehicles, which makes it possible to attach an energy storage device in a secure and space-saving manner. A further object is to provide a lifting platform, in particular a mobile lifting platform for vehicles, which offers improved movability/movability and improved positionability, in particular of the lifting device thereof. The features of the independent claims are proposed for achieving the objects. Advantageous embodiments can be found in the dependent claims.

In detail, a control device for a lifting platform, in particular for a mobile lifting platform for vehicles, is disclosed, which comprises control electronics, an energy storage device and a housing. The mobile vehicle lifting platform can particularly preferably be a mobile column lifting platform.

The control electronics are configured to control a drive of the lifting platform in order, for example, to raise or lower a lifting device of the lifting platform, while the energy storage device is configured to provide energy for the drive of the lifting platform. The control electronics and the energy storage device are both arranged in the housing of the control device. In this case, the control electronics can preferably be arranged on a circuit board and comprise a plurality of electronic components (control circuit board).

By means of the control electronics, for example, a position/height of the lifting device and an adjustment/lifting speed for reaching this position can be set. In addition, a plurality of lifting platforms can be combined into a group and controlled jointly by the control electronics. In this case, the control electronics can, for example, provide synchronization control/regulation, i.e. control/regulate the drive of each individual lifting platform in such a way that the lifting devices thereof move to the same height at the same speed. Furthermore, the control electronics can receive signals from a plurality of sensors which are attached to each lifting platform and, for example, carry out safety functions on the basis of the received signals. For example, the control electronics can stop the movement of the lifting devices of a group of lifting platforms if an impermissible deviation between the lifting speeds thereof is detected. The data/signal transmission between the individual lifting platforms can take place by radio and/or cable.

The energy storage can preferably be an electrical energy storage, in particular an accumulator (secondary battery). In order to provide the electrical energy, the energy storage can be connected to the drive of the lifting platform via a cable. Furthermore, the energy storage can be electrically connected to the control electronics in order to provide the supply energy for the latter and in order to transmit control signals between the energy storage device and the control electronics. For example, the control electronics can monitor the charge state of the accumulator and/or the temperature thereof.

As a result of the arrangement of the control electronics and the accumulator in a common housing, the electrical lines between the two elements can be made very short, as a result of which the cabling outlay on the lifting platform can be reduced. In addition, the integration of the accumulator into the housing of the control device makes it possible to accommodate the latter in a very space-saving and at the same time secure manner since it is protected in the housing from external influences, such as, for example, moisture.

According to one embodiment, the control device can additionally comprise a plate which is likewise arranged in the housing. In this case, the control electronics can be arranged on a first side of the plate and the energy storage device can be arranged on a second side opposite the first side of the plate. In other words, the plate can divide the housing into two chambers/regions in which the control electronics and the energy storage device can be arranged in each case. The plate can preferably be arranged in the center of the housing and divide the latter into two chambers of substantially equal size. The plate can particularly preferably be arranged in the housing in such a way that a sufficiently large chamber/a sufficiently large region for the control electronics is formed opposite the first side of the plate and a sufficiently large chamber/a sufficiently large region for the energy storage device is formed opposite the second side of the plate.

According to one embodiment, the housing can be produced from a plastic and the plate can be produced from a metal. The plastic can preferably be an impact-resistant plastic such as, for example, ABS (acrylonitrile-butadiene-styrene). Other impact-resistant plastics are likewise possible. The use of plastic allows the housing to be produced in a weight-saving manner and therefore to be attached at any desired point of the lifting platform.

The plate can preferably be produced from a metal which has good thermal conductivity properties in order to dissipate the heat generated by the energy storage device. The plate can preferably be produced from aluminum since, in addition to good thermal conductivity, the latter also has a low weight.

According to a further embodiment, the energy storage device can bear against the second side of the plate. In other words, the energy storage device can be in contact directly with the opposite second side of the plate on one side in order to ensure good heat dissipation. For this purpose, the energy storage device can, for example, be fastened on the plate in such a way that it bears completely against the latter with one side. For example, the energy storage device can be screwed onto the plate. Alternatively, the plate can have, for example, holders with which the energy storage device can be clamped flat against the plate. The plate can thus serve both for fastening/holding and for cooling the energy storage device.

According to one embodiment, the housing can be of two-part design. In particular, a first housing part on the first side and a second housing part on the second side of the plate can be connected thereto. In other words, the housing contains two parts which are fastened in each case on the opposite sides (first and second side) of the plate. For example, the first and second housing part can be screwed in each case to the plate. This makes possible both a stable and a maintenance-friendly design of the control device.

In particular, the stability of the plastic housing can be increased by the screwing of the housing parts to the metal plate. At the same time, the control electronics and the energy storage device are accessible separately from one another by the separate fastening of the individual housing parts to the opposite sides of the plate. This means that, for example, only the second housing part has to be unscrewed in order to reach the energy storage device and, during this, the control electronics can remain protected in the opposite chamber of the housing.

The described embodiment of the disclosure thus makes possible an integral design of the control device, which comprises both the control electronics and the energy storage device, but at the same time offers a modular arrangement of the elements within the control device or the housing thereof, which allows simple access to the individual elements.

According to one embodiment, the control device can comprise a control panel which is arranged in the first housing part. In particular, the control panel can be integrated in the first housing part, i.e. the control panel and the first housing part can be a common component. In this case, the control panel can be attached to an opposite side of the control circuit board arranged in the first housing part and can be electrically connected thereto. This means that control commands from the control panel can be received directly by the control electronics and can be processed further. The control panel can contain, in particular, buttons for lifting and lowering the lifting device of the lifting platform. At least parts of the control panel can be designed as a film keyboard.

According to one embodiment, the energy storage device can have a plurality of energy storage cells. In the event that the energy storage device is designed as an accumulator, said energy storage device can have, for example, a plurality of individual accumulator cells which are interconnected to one another. In this case, the individual cells can have, for example, a cylindrical or a cubic shape. Any other external shape of the accumulator cell is likewise possible. This makes it possible to provide accumulators which can have both different voltages and capacitances and different geometries. In particular, an external geometry of the accumulator used can be adapted to the available space/the available volume in the interior of the second housing part.

According to one embodiment, the energy storage device can be a high-power accumulator, in particular a lithium-ion accumulator. Further high-power accumulators, such as, for example, lithium-sulfur or magnesium-sulfur accumulators and/or any other suitable accumulator type can likewise be provided. Furthermore, solid-state batteries can also be used.

Furthermore, a lifting platform, in particular a mobile lifting platform for vehicles, is disclosed, which comprises a base device, a lifting column, a lifting device, a drive and a control device as described above. The mobile lifting platform can particularly preferably be a mobile column lifting platform.

The base device of the lifting platform can be set up on a floor, i.e. the base device can be set up, for example, on the floor of a workshop or can rest thereon. The base device can have, for example, a carriage/a movable carriage with a base frame which can rest on the workshop floor after the lifting platform has been moved to the desired point by means of the carriage. Alternatively, the base device can also be designed as a carrier plate or mounting plate.

The lifting column is connected to the base device and a lifting device is arranged on the lifting column and can be moved along the lifting column by means of the drive. In other words, the drive can lift the lifting device relative to the lifting column and lower it again.

The drive is preferably controlled and supplied with energy by the control device which contains control electronics and an energy storage device. For this purpose, the control device can be electrically connected to the drive, for example, by means of one or more cables. The control electronics and the energy storage device are both arranged in a housing of the control device. As a result of this arrangement, in particular the energy storage device can be attached to the lifting platform in a very space-saving manner and at the same time protected from environmental influences.

The control device of the lifting platform can preferably additionally comprise a control panel into which control commands can be input. In particular, the lifting device can be lifted and lowered on the control panel by means of corresponding buttons. Furthermore, a grouping of a plurality of lifting platforms to form a system can be performed via the control panel.

The lifting platform can furthermore contain a plurality of sensors, such as, for example, position sensors, displacement sensors, rotation sensors etc., the signals of which sensors can be received by the control electronics and can be used to control the lifting device or to carry out safety functions.

Furthermore, the lifting platform can comprise a transmitter/receiver which can transmit signals to adjacent lifting platforms and/or to a central control unit and/or can receive signals from the latter. This can preferably be a radio transmitter/receiver. Alternatively or additionally, the lifting platform can contain connections which make possible a wired data transmission to one or more adjacent lifting platforms and/or to a central control unit. A plurality of lifting platforms can thus be combined into a group and controlled jointly by means of the control electronics. In this case, the control electronics can, for example, provide synchronization control/regulation, i.e. control/regulate the drive of each individual lifting platform in such a way that the lifting devices thereof move to the same height at the same speed.

The lifting device can contain a guide means for guidance along the lifting column and a receiving means for receiving a load. In particular, the lifting device can be a lifting carriage which has a carriage guide and a receiving fork. The receiving fork can, in particular, be configured to receive a wheel of a vehicle.

The drive can preferably be designed as a spindle drive. In this case, the lifting device can be moved up and down by means of a lifting spindle attached in the lifting column. For this purpose, the lifting device can be connected to a carrying nut which is in engagement with the lifting spindle. The lifting spindle can be driven by a motor, in particular by an electric motor, via a suitable transmission. Alternatively, a hydraulic drive of the lifting device is also possible.

According to one embodiment, the control device can be arranged in a region of an upper end of the lifting column. This is intended to be understood to mean, in particular, a region above half the height of the lifting column. Preferably, the control device can be arranged in a region between half the height and the overall height of the lifting column. As a result, the region at the foot/at the lower end of the lifting column can remain free, as a result of which the handleability/operability of the lifting platform can be improved. The latter can be realized, in particular, by virtue of the fact that the energy storage device of the lifting platform is integrated in the control device, that is to say is arranged in a housing of the control device.

According to one embodiment, the lifting platform can comprise at least one carrier which is connected to the base device and/or to the lifting column and which receives the control device. In other words, the control device can be fastened to at least one carrier which is connected to the base device and/or to the lifting column. The at least one carrier can preferably be arranged substantially vertically. In this case, substantially vertical is intended to be understood to mean an angle of less than or equal to 35 ° in relation to the perpendicular direction.

Furthermore, the carrier can be arranged on a side of the lifting column facing away from the lifting device. In particular, the carrier can be arranged on the side of the lifting column facing away from the lifting device in such a way that it is concealed by the lifting column in a front view of the lifting platform with a view of the lifting device.

In this way, the control device with the control electronics and the energy storage device is attached to the lifting platform in a manner decoupled from the lifting column, with the result that, for example, mechanical loads which act on the lifting column, for example as a result of the lifting/lowering of the lifting device, are not transmitted directly to the control device. As a result of the control device being received on the carrier, the energy storage device located in the control device is thus once again better protected from environmental influences.

The carrier can preferably be of two-part design, wherein a first part of the carrier can be connected to the base device on one side and to an underside of the control device on another side. In this case, a second part of the carrier can be connected to the lifting column on one side and to an upper side of the control device on another side. As a result of the two-part design of the carrier, the attachment of the control device with the control electronics and the energy storage device to the lifting platform can be facilitated.

According to one embodiment, a first housing part of the control device can be arranged facing away from the lifting column, and a second housing part of the control device can be arranged facing the lifting column. This means that the first housing part of the control device, into which, in particular, the control panel can be integrated, is preferably arranged on an outer side of the lifting platform in order to make simple accessibility to the control panel possible. By contrast, the second housing part can preferably be arranged on an inner side of the lifting platform, particularly preferably between the first housing part and the lifting column. In particular, the second housing part can contain the energy storage device which can additionally be protected from external influences by the position in an inner region of the lifting platform.

In addition, a system is disclosed which comprises one or more of the lifting platforms described above. Each of the lifting platforms has a control device which comprises control electronics for controlling a drive of the lifting platform and an energy storage device for providing the energy for the drive. The control electronics and the energy storage device are both arranged in a housing of the control device, and the control device can preferably be arranged in each case in a region of an upper end of a lifting column of the corresponding lifting platform.

The system can preferably comprise a group of up to eight lifting platforms. A higher or lower number of lifting platforms in the system is likewise possible. The system can be controlled by any desired control device of the grouped lifting platforms and/or by means of a central control unit. In this case, the individual lifting platforms can communicate with one another and/or with the central control unit by means of a radio transmitter/receiver and/or in a wired manner.

In summary, the present disclosure makes it possible to attach an energy storage device to a lifting platform, in particular to a mobile lifting platform for vehicles, in a secure and space-saving manner by said energy storage device being arranged jointly with control electronics in a housing of the control device of the lifting platform. As a result of the arrangement of the control electronics and the energy storage device in a common housing, the electrical lines between the two elements can be made very short, as a result of which the cabling outlay on the lifting platform can be reduced. Since the control device is preferably arranged in a region of an upper end of a lifting column of the lifting platform, the lower region of the lifting column can additionally remain free. This additionally improves the handleability of the mobile lifting platform since the latter can be moved and positioned in a simpler manner as a result.

### BRIEF DESCRIPTION OF THE FIGURES

FIG. 1 shows schematically a mobile column lifting platform according to an exemplary embodiment of the present disclosure in a three-dimensional illustration; and

FIG. 2a to 2c show schematically a control device according to an exemplary embodiment of the present disclosure in a three-dimensional illustration and in a front view and a sectional illustration.

### DETAILED DESCRIPTION OF EXEMPLARY EMBODIMENTS

Exemplary embodiments of the present invention are described in detail below on the basis of exemplary figures. The features of the exemplary embodiments can be combined as a whole or in part and the present invention is not restricted to the exemplary embodiments described. In the figures, identical elements are provided with identical reference symbols, with the result that a repeated description of the elements is dispensed with if this is not necessary.

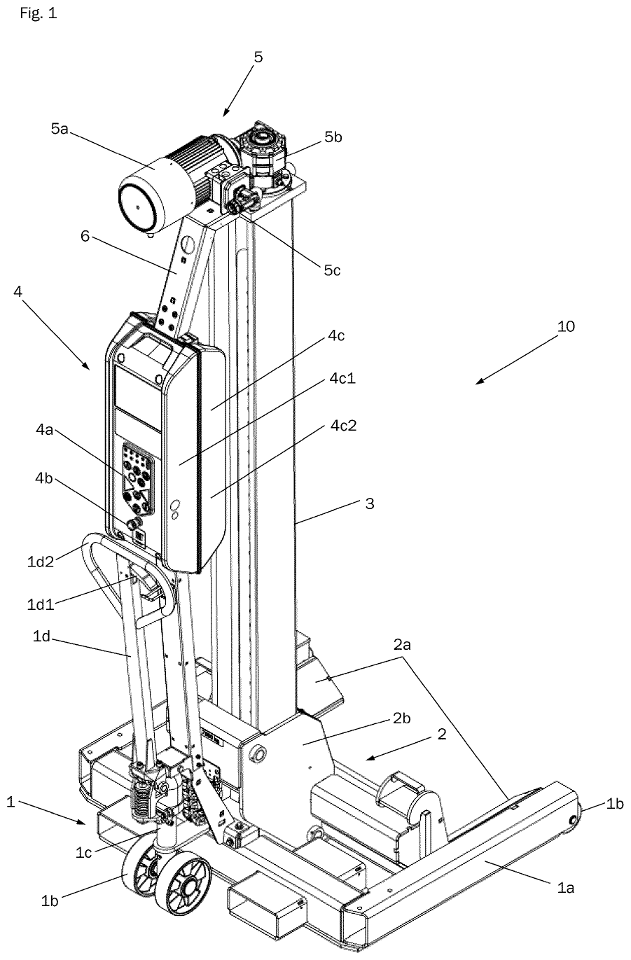

FIG. 1 shows schematically a mobile column lifting platform 10 according to an exemplary embodiment of the present disclosure in a three-dimensional illustration. The mobile column lifting platform shown comprises a base device 1 in the form of a carriage 1, a lifting device 2, a lifting column 3, a control device 4 and a drive 5.

The carriage 1 has a base frame 1a, wheels 1b, a hydraulic cylinder 1c and a drawbar 1d with an operating lever 1d1 and a handle 1d2.

In a stationary state of the lifting platform 10, the base frame 1a, which is in the form of a U-shaped frame construction in the exemplary embodiment shown, rests fixedly, for example on a floor of a workshop, and therefore makes possible a stable standing of the lifting platform 10.

In order to move the lifting platform 10 in the workshop, the base frame 1a can be lifted from the floor of the workshop by means of the hydraulic cylinder 1c and can be moved to a desired point in the workshop by pulling/pushing on the handle 1d2 of the drawbar 1d on the wheels 1b. In order to raise the base frame 1a, the operating lever 1d1, which in the exemplary embodiment illustrated is attached to an upper end of the drawbar 1d, can be brought into a first position, as a result of which a hydraulic valve (not illustrated) is closed.

If hydraulic fluid (not illustrated) is pumped into the hydraulic cylinder 1c by means of an up and down movement (pumping movement) of the drawbar 1d, the latter lifts the base frame 1a. When the lifting platform 10 is placed at the desired point, the hydraulic valve can be opened by moving the operating lever 1d1 into a second position, with the result that the hydraulic fluid can flow out of the hydraulic cylinder 1c and the latter can lower the base frame 1a again onto the workshop floor.

The lifting column 3 is fastened to the base frame 1a of the carriage 1 in such a way that it likewise stands firmly on the workshop floor when the base frame 1a is completely lowered and rests on the workshop floor. In the exemplary embodiment shown, the lifting device 2 is designed as a lifting carriage 2 with a carriage guide 2b and a receiving fork 2a. In this case, the carriage guide 2b serves for defined movement of the lifting carriage 2 along the lifting column 3 and the receiving fork 2a serves for receiving loads. For example, a wheel of a vehicle can be received/held by the receiving fork 2a.

In the exemplary embodiment illustrated, the drive 5 of the lifting carriage 2 is designed as a spindle drive. The latter can preferably comprise a motor 5a, which can be, in particular, an electric motor 5a, a transmission 5b and a lifting spindle (not illustrated). An electrical connection 5c, to which a connecting cable (not illustrated) to an energy storage device (not illustrated) can be connected, is provided on the electric motor 5a illustrated. The lifting spindle can be arranged in the lifting column 3 and can be in engagement with a carrying nut (not illustrated) which is connected to the lifting carriage 2. By rotating the lifting spindle by means of the motor 5a and the transmission 5b, the lifting carriage 2 fastened to the carrying nut can be moved in the vertical direction along the lifting column 2. It is likewise possible for the lifting carriage 2 to be moved by means of a hydraulic drive.

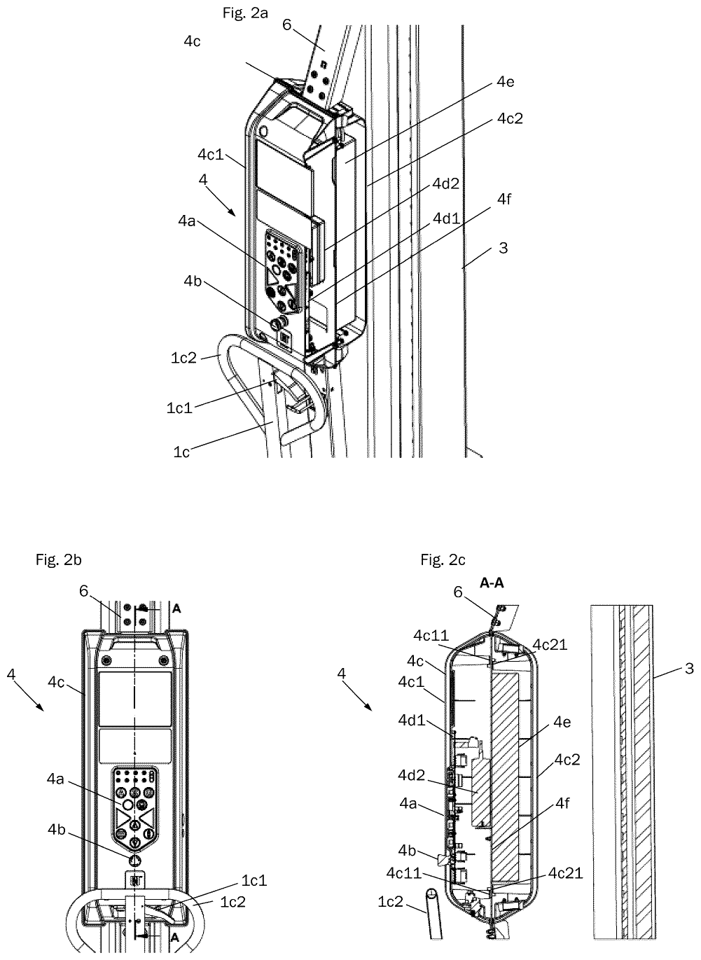

To control the drive 5, the control device 4 is provided on the lifting platform 10. The control device 4 shown comprises a control panel 4a and an emergency stop switch 4b, which are attached to a housing 4c of the control device or are integrated therein. The housing 4c is preferably produced from a plastic and comprises a first housing part 4c1 which is arranged on a side facing away from the lifting column 3, and a second housing part 4c2 which is arranged on a side facing the lifting column 3. Located in the interior of the housing 4c are a control circuit board, an energy storage device and a charger for charging the energy storage device, for example by means of a mains voltage. The elements arranged in the interior of the control device are described in more detail below in conjunction with FIGS. 2a to 2c.

The control device 4 is attached to a two-part carrier 6, the upper part of which is connected to the lifting column 3 on one side and to an upper side of the control device 4 on another side. The lower part of the carrier 6 is in turn connected to the base frame 1a of the carriage 1 on one side and to an underside of the control device 4 on another side.

As a result of the two-part design of the carrier 6, the mounting of the control device 4 on the lifting platform 10 can be facilitated. In addition, the attachment of the control device 4 to a separate carrier 6 makes it possible to decouple the latter from the lifting column 3, with the result that, for example, mechanical loads which act on the lifting column 3, for example as a result of the lifting/lowering of the lifting device 2, are not transmitted directly to the control device 4.

The carrier 6 shown is arranged substantially vertically, wherein substantially vertical is intended to be understood to mean an angle of less than or equal to 35° in relation to the perpendicular direction. In this case, the carrier 6 is arranged on a side of the lifting column 3 facing away from the lifting device 2 in such a way that it is concealed by the lifting column 3 in a front view of the lifting platform 10 with a view of the lifting device 2. Therefore, the carrier 6 is shielded by the lifting column 3 from influences by the movement of the lifting carriage 2.

In the embodiment shown, the first housing part 4c1 of the control device 4 is arranged facing away from the lifting column 3, and the second housing part 4c2 of the control device 4 is arranged facing the lifting column. As a result, the first housing part 4c1 with the control panel 4a is arranged on an outer side of the lifting platform 10 and is thus easily accessible to an operator. By contrast, the second housing part 4c2 is arranged on an inner side of the lifting platform 10, namely between the first housing part 4c1 and the lifting column 3, with the result that the risk of damage to the second housing part 4c2 by external influences is very low.

FIGS. 2a to 2c show schematically a control device 4 according to an exemplary embodiment of the present disclosure in a three-dimensional illustration and in a front view and a sectional illustration.

FIG. 2a illustrates a detail of the lifting platform 10 from FIG. 1, which detail shows the control device 4 with a laterally open housing 4c. As a result, parts of the control circuit board 4d1, the charger 4d2 and the energy storage device 4e are visible. The control circuit board 4d1 is attached to a side opposite the control panel 4a and is electrically connected thereto. Furthermore, the control circuit board 4d1 is fastened mechanically to the first housing part 4c1.

A plate 4f, which divides the latter into two chambers/regions, is arranged in the center of the housing 4c. The charger 4d2 and the energy storage device 4e are attached to opposite sides of the plate 4f. The energy storage device 4e shown is preferably an accumulator 4e, in particular a lithium-ion accumulator 4. The plate 4f can preferably be designed from metal, in particular from aluminum, in order to be able to dissipate the heat of the charger 4d2 and of the accumulator 4e well. The thermal contact of the charger 4d2 and of the accumulator 4e with the metal plate 4f is illustrated once again by the illustration of the control device 4 in FIGS. 2b and 2c.

FIG. 2b shows the control device 4 in a front view with a view of the control panel 4a. In this case, a sectional plane A-A, which is illustrated in FIG. 2c, is defined in FIG. 2b. In this sectional view A-A of FIG. 2c, the control circuit board 4d1, which is arranged in the first housing part 4c1 and has the electronic components mounted thereon, and the charger 4d2 can be seen well. It becomes clear that the circuit board 4d1 is arranged on the rear side of the control panel 4a, with the result that no additional wiring is necessary between the control panel 4a and the control circuit board 4d1. The charger 4d2 is arranged flat on the metal plate 4f in order to ensure good heat dissipation with respect thereto.

The same applies to the accumulator which is arranged in the second housing part 4c2 and likewise bears flat against the metal plate 4f. The latter is screwed to the carrier 6, which can preferably likewise be produced from metal. As a result, the heat which is emitted by the charger 4d2 and the accumulator 4e to the metal plate 4f can be emitted to the outside via the carrier 6.

Furthermore, mounting points 4c11 and 4c22 for the two housing parts 4c1, 4c2 on the metal plate 4f can be seen in FIG. 2c. These are arranged offset with respect to one another on both sides of the metal plate 4f, with the result that they do not influence one another.

For access to the mounting points, injection-moulded domes, by means of which the two housing parts 4c1, 4c2 can be screwed to the metal plate 4f, are provided in the housing 4c.

The stability of the plastic housing 4c can be increased by the screwing of the housing parts 4c1, 4c2 to the metal plate 4f. At the same time, the control circuit board 4d1 and the accumulator 4e are accessible separately from one another by the separate fastening of the individual housing parts 4c1, 4c2 to the opposite sides of the plate 4f. This means that, for example, only the second housing part 4c2 has to be unscrewed in order, for example, to exchange the accumulator and, during this, the control circuit board 4d1 can remain protected in the opposite chamber of the housing 4c.

In summary, the exemplary embodiments of the present disclosure described above make it possible to attach an energy storage device 4e to a mobile column lifting platform 10 in a secure and space-saving manner by said energy storage device being arranged jointly with a charger 4d2 and a control circuit board 4d1 in a housing 4c of the control device 4 of the lifting platform 10. As a result of the arrangement of the control circuit board 4d1, the charger 4d2 and the energy storage device 4e in a common housing 4c, the electrical lines between the individual elements can be made very short, as a result of which the cabling outlay on the lifting platform 10 can be reduced. Since the control device 4 is preferably arranged in a region of an upper end of a lifting column 3 of the lifting platform 10, the lower region of the lifting column 3 can additionally remain free. This additionally improves the handleability of the mobile mobile column lifting platform 10 since the latter can be moved and positioned in a simpler manner as a result.

1. Control device for a lifting platform, in particular for a mobile lifting platform for vehicles, comprising:
control electronics which are configured to control a drive of the lifting platform,
an energy storage which is configured to provide energy for the drive of the lifting platform, and
a housing in which the control electronics and the energy store are arranged.

2. Control device according to claim 1, which comprises a plate which is arranged in the housing, wherein the control electronics are arranged on a first side of the plate and the energy storage is arranged on a second side opposite the first side of the plate.

3. Control device according to claim 2, wherein the housing is produced from a plastic and the plate is produced from a metal.

4. Control device according to claim 2, wherein the energy storage (4e) bears against the second side of the plate.

5. Control device according to claim 2, wherein the housing is of two-part design, and a first housing part on the first side and a second housing part on the second side of the plate are connected thereto.

6. Control device according to claim 5, which comprises a control panel which is arranged in the first housing part.

7. Control device according to claim 1, wherein the energy storage has a plurality of energy storage cells.

8. Control device according to claim 1, wherein the energy storage is a high-power accumulator, in particular a lithium-ion accumulator.

9. Lifting platform, in particular a mobile lifting platform for vehicles, comprising
a base device, by means of which the lifting platform can be set up on a floor;
a lifting column which is connected to the base device;
a lifting device which is arranged on the lifting column and can be moved along the lifting column;
a drive which is configured to drive the lifting device, and
a control device, comprising:
control electronics which are configured to control a drive of the lifting platform,
an energy storage which is configured to provide energy for the drive of the lifting platform, and
a housing in which the control electronics and the energy store are arranged.

10. Lifting platform according to claim 9, wherein the control device is arranged in a region of an upper end of the lifting column.

11. Lifting platform according to claim 9, which comprises at least one carrier, which is connected to the base device and/or to the lifting column and which receives the control device.

12. Lifting platform according to claim 9, wherein a first housing part of the control device is arranged facing away from the lifting column, and a second housing part of the control device is arranged facing the lifting column.

13. System comprising:
one or more lifting platforms, each of the one or more lifting platforms comprising:
a base device, by means of which the lifting platform can be set up on a floor;
a lifting column which is connected to the base device;
a lifting device which is arranged on the lifting column and can be moved along the lifting column;
a drive which is configured to drive the lifting device, and
a control device, comprising:
control electronics which are configured to control a drive of the lifting platform,
an energy storage which is configured to provide energy for the drive of the lifting platform, and
a housing in which the control electronics and the energy store are arranged.
